(19) United States
(12) Patent Application Publication
(10) Pub. No.: US 2026/0107246 A1
(43) Pub. Date: Apr. 16, 2026

(54) CONNECTION-SPECIFIC OVERLOAD PROTECTION FOR ACCESS AND MOBILITY MANAGEMENT

(71) Applicant: Google LLC, Mountain View, CA (US)

(72) Inventor: Mohamed Negm, Hamburg (DE)

(21) Appl. No.: 19/120,717

(22) PCT Filed: Oct. 25, 2023
(86) PCT No.: PCT/US2023/077715

§ 371 Date: Apr. 11, 2025

Related U.S. Application Data
(60) Provisional application No. 63/381,418, filed on Oct. 28, 2022.

(51) Int. Cl. H04W 60/04; H04L 5/00; H04W 8/20; H04W 76/30

(52) U.S. Cl. CPC H04W 60/04; H04L 5/0053; H04W 8/20; H04W 76/30

(57) ABSTRACT

Methods and systems are disclosed for incorporating user equipment (UE) device connection priorities to network connection decisions in response to network overloading events 460. For example, overload protection procedures may apply to specific connections, such as based on apriority level of a UE device and/or a specific tracking area (TA). For example, an access and mobility management function, AMF 320 may grantor maintain 468 connections with higher priority levels notwithstanding overload protection mechanisms. This reduces disruption of important connections as predefined to the AMF. When a network entity that handles connection registration, such as an AMF, detects one or more overloading events, instead of rejecting connection requests or disconnecting connections absent priority information, the network entity may take actions 466 only against connections of low priority. The connections priority may include one of or both UE device specific priority and TA priority related to radio access networks (RANs).

### CROSS-REFERENCE TO RELATED APPLICATIONS

This application claims the benefit of and priority to U.S. Provisional Application Ser. No. 63/381,418, entitled “Connection-Specific Overload Protection for Access and Mobility Management,” filed on Oct. 28, 2022, the disclosures of which are incorporated herein by reference in their entirety.

### FIELD

The present disclosure relates generally to wireless communications, and more particularly, to systems and methods of traffic overload protection.

### BACKGROUND

The Third Generation Partnership Project (3GPP) 5G New Radio (5G NR) architecture includes three components: a 5G Radio Access Network (5G-RAN), a 5G Core Network (5GC), and a User Equipment (UE). For example, a UE registers with the 5GC via the 5G-RAN for establishing a signaling connection with the 5GC. An access and mobility management function (AMF) of the 5GC manages the registration request. That is, the AMF manages registration and de-registration (e.g., authorizing or rejecting requests) of various UEs attempting to access the 5GC.

The AMF does not grant all registration requests. For example, when signaling load exceeds a limit, the AMF may start an overload protection procedure to decline new connection attempts or disconnect existing connections. The overload protection procedure protects some of the existing connections by limiting or stopping new UE device registrations. Using this mechanism, though, some important registration/connection attempts (e.g., attempts by officials in a disaster response scenario) may fail to timely access wireless communication services in deference to existing traffic connections.

### SUMMARY

The present disclosure provides methods and techniques for incorporating user equipment (UE) device connection priorities to network connection decisions in response to network overloading events. For example, overload protection procedures may apply to specific connections, such as based on a priority level of a UE device and/or a specific tracking area (TA) also called a RAN-based Notification Area (RNA).

In wireless communication networks, network functions might become overloaded as signaling increases. If one AMF handles multiple sessions from a number of UE devices, the AMF might become overloaded when usages involving multiple UE devices spike (e.g., such as when many active devices become concentrated in one area or location), referred to as overload events.

Upon detecting overload events, the AMF may take actions to reduce the overload, such as to reject connection signaling, to reject non-emergency traffic, and/or limit traffic to emergency only (collectively referred to as overload protection mechanisms).

Current practice does not consider UE device or location contexts when the AMF triggers overload protection mechanisms. Although an AMF may continue to accept some emergency traffic when overload protection mechanisms are triggered, the AMF often disregards the nature of the radio access network (RAN) or the UE device. Some communications of high priority, such as connections involving emergency response (and personnel thereof), law enforcement, public safety, among others, may benefit from uninterrupted connections during events that contribute to overloading conditions. Allowing for such higher priority connections during overload over lower priority connections may avoid irreparable harm. Therefore, aspects of the present disclosure enhance the overload protection mechanisms by considering a UE device specific profile, the UE device's location priority, and other priority information.

According to aspects of the present disclosure, an AMF may grant or maintain connections with higher priority levels notwithstanding overload protection mechanisms. This reduces disruption of important connections as predefined to the AMF. For example, when a network entity that handles connection registration, such as an AMF, detects one or more overloading events, instead of rejecting connection requests or disconnecting connections absent priority information, the network entity takes actions only against connections of low priority. The connections priority may include one of or both UE device specific priority and tracking area (TA) priority related to radio access networks (RANs). The UE device specific priority enables connection or authorization requests by certain UE devices (e.g., UE devices registered to important officials) to proceed without overload protection interference. TA-specific priority enables certain base stations of a RAN to avoid overload protection procedures (e.g., the AMF not initiating overload protection at the TA even if it detects overloading). In some cases, when the two priorities are combined, specific UE devices may proceed with connection requests at specific TAs even when a corresponding AMF has detected overloading at those specific TAs.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram depicting an example architecture involving an overload protection procedure for connections between UE devices and radio access network, according to some embodiments;

FIG. 2 is an example diagram depicting an overload protection procedure, according to some embodiments;

FIG. 3 is a signaling diagram depicting example registration requests by multiple UE devices and a method of connection-specific overload protection, according to some embodiments;

FIG. 4 is a signaling diagram depicting an example execution of connection-specific overload protection during traffic overload in response to the registration requests shown in FIG. 3, according to some embodiments:

FIG. 5 is a signaling diagram depicting another example execution of connection-specific overload protection during traffic overload, according to some embodiments;

FIG. 6 is a flow diagram depicting a method of connection-specific overload protection for access and mobility management by an access and mobility management function (AMF), according to some embodiments; and

FIG. 7 is a flow diagram depicting a method of connection-specific overload protection for access and mobility management by a network repository function (NRF).

### DETAILED DESCRIPTION

For ease of illustration, the following techniques are described in an example context in which one or more user equipment (UE) devices and radio access networks (RANs) implement one or more radio access technologies (RATs) including at least a Fifth Generation (5G) New Radio (NR) standard (e.g., Third Generation Partnership Project (3GPP) Release 15, 3GPP Release 16, etc.) (also referred to as, “5G NR” or “5G NR standard”). However, the present disclosure is not limited to networks employing a 5G NR RAT configuration, but rather the techniques described can be applied to any combination of different RATs employed at the UE devices and the RANs. Also, the present disclosure is not limited to the examples and context described, but rather the described techniques can be applied to any network environment.

The present disclosure considers the UE device and/or its location to allow specific UE devices to overcome overload restrictions based on the locations of the UE devices. That is, an access and mobility management function (AMF) may deny (e.g., having a RAN reject) a UE device access to the network during overload times, except when the UE device is located in a strategic or high-priority location and/or when the UE device has a high-priority subscriber profile, or other priority information. The priority information indicates that the UE device-specific connection is valuable and important and may override conventional overload protection mechanisms (e.g., rejections or disconnections). The disclosed UE device-specific prioritization may combine with traffic prioritization and other exceptions to the overload protection mechanism.

An AMF may grant or maintain connections with higher priority levels notwithstanding overload protection mechanisms. Conventionally, the overload protection mechanisms prevent the AMF from granting or authorizing new UE registration requests when the AMF detects overloading events (e.g., the AMF being under excessive workload). The present disclosure provides exemptions to certain high priority UEs even in cases where the AMF has been overloaded, and thus reduces disruption of important connections to the AMF. During operation, the AMF is consulted every time a connection is being established or de-established. The connection establishment request includes some parameters that map to a specific AMF. The AMF often does not act on existing connections unrelated to the connection establishment request (e.g., not being handed over from or to another network entity). For example, when a network entity that handles connection registration, such as an AMF, detects one or more overloading events, instead of rejecting connection requests or disconnecting connections absent priority information, the network entity (e.g., the AMF) may reject only connection requests of low priority and authorize certain requests involving high connection priority. The connection priority may include one of or both UE device-specific priority and tracking area (TA) priority related to radio access networks (RANs).

According to aspects of the present disclosure, a first network entity, such as an AMF, receives a request by a RAN for registration or authentication of a UE device on the first network entity. The first network entity transmits a request for subscriber data about the UE device to a second network entity. The first network entity receives, from the second network entity, a message with subscriber data about the UE device. The subscriber data indicates a priority level regarding a connection between the UE device and the RAN. The first network entity detects an overload event and, in response, notifies the RAN with an indication of action based on the priority level indicated in the subscriber data. For example, the indication of action may include establishing or maintaining a connection between the UE device and the RAN when the priority level is above a threshold level.

The priority information may include a TA priority level of the RAN. A TA includes a logical group of cells, which correspond to antenna coverages characterized by frequencies and ranges. A registration area (RA) may include one or more TAs assigned to a UE device. A network may use an RA to search for the UE device. The UE device may report its physical/geographical location based on RA information. The AMF may differentiate various registration requests based on the TA priority levels of RANs. As such, the traffic of a high priority RAN may continue while disregarding network slicing configurations or overloading events. A high priority RAN may include locations of high importance, such as a base station near a police station, fire station, hospital, government building, among others. In some cases, a network repository function (NRF) may store the TA priority levels. A TA priority level of a RAN may be associated with a characterization of a physical location corresponding to a logical TA to which the RAN belongs.

For example, an RA may include multiple TAs of various priority levels. The NRF may include a priority identifier, a list of high priority TAs, a priority level threshold, and assigned values of priority levels to the TAs, etc. When the TA priority level is high or above a threshold level (or otherwise fulfills the threshold criterion), the AMF ignores the overload event for that TA and, in that TA, establishes or maintains a connection between the UE device and the RAN. When the TA priority level is not high or not above the threshold level, the AMF may terminate or fail a connection between the RAN and the UE device in that TA in compliance with the general overload protection mechanism.

In addition to a TA priority level, the priority information may include a device priority level of the UE device recorded in a unified data management (UDM) or a unified data repository (UDR) associated with the UDM. The subscriber profiles in the UDM may contain priority details of the UE devices, indicating whether a UE device is a high-profile subscriber for purposes of overriding the general overload protection mechanism.

When both the UE device-specific priority level and the TA priority level are considered, the AMF may avoid interrupting UE-RAN connections in example situations including: police officers' or firefighters' work phone in their operating districts. This allows the network to balance overload protection and UE device-specific connection priorities. For example, when receiving a request from a UE device regarding establishing or authenticating a connection (e.g., “regarding” meaning “related to” or “associated with”), the AMF may determine whether to comply with or bypass the general overload protection mechanism, based on: (1) priority specific to the UE device; (2) priority specific to a TA in which the UE device sends the request; or (3) priority specific to both a TA and a UE device. In some situations, the high-profile subscriber status may be associated with a particular TA's priority levels (e.g., an ambassador's work phone in the office). The priority details may enable the UE device to override general network overload protection mechanisms to reduce connection rejections or interruptions.

A common physical location may correspond to an RA of a vertical network slice. A vertical network slice may be location specific (e.g., BS. TA, or RA specific), as opposed to performance specific (e.g., latency, through-put, etc.). For example, vertical slices may include hospitals, airports, university campuses, stadiums, and the like; while horizontal network slices may include slices for real-time control, IoT and sensors, and video streaming. Each TA may include multiple cells and make use of various horizontal network slices, such as high bandwidth, ultra-low latency (e.g., URLLC, for real-time control), low energy or low bandwidth for internet-of-things (IoTs), as well as ultra-high bandwidth (e.g., for video streaming). Therefore, the TA priority levels aligned with either vertical or horizontal network slices may further allow UE device-specific connection prioritization at a common geographic location.

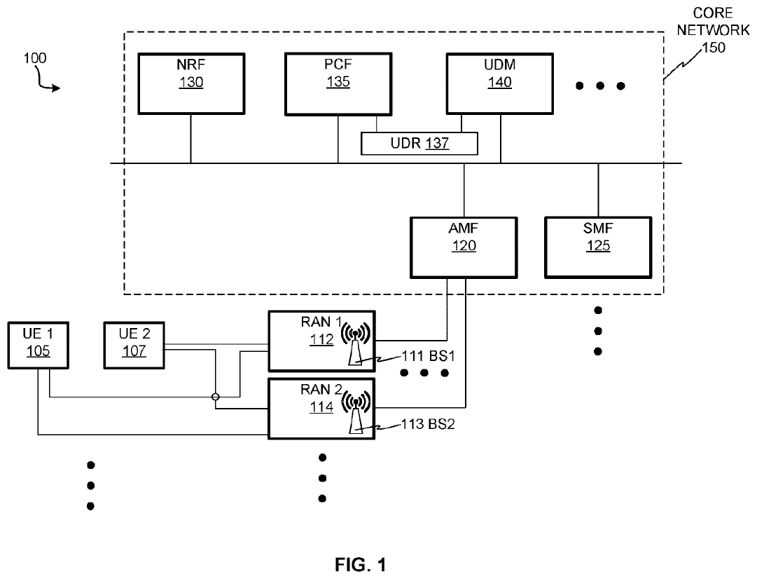

FIG. 1 is a block diagram depicting an example architecture 100 involving an overload protection procedure for connections between UE devices (105 and 107) and radio access network (RANs, 112 and 114), according to some embodiments. The example architecture 100 may represent a 5G NR network architecture or future network architecture that include same or similar functional components (e.g., AMF, SMF, UDM, etc.). As shown, the RANs 112 and 114 may respectively include one or more base stations (BSs) 111 and 113, with respective antennas (not separately shown). The coverage areas of the RANs 112 and 114 may vary substantially depending on the antennas. RAN hardware, and software thereon.

During operation, the UE devices 105 and 107 communicate wireless signals with the BSs 111 and 113. In some examples, the BSs 111 and 113 receive information from the UE devices 105 and 107. The RANs 112 and 114 may include radio units (RUs), distributed units (DUs), and/or central units (CUs) for processing the received information. The RANs 112 and 114 may then communicate the processed information with the core network 150, which includes an access and mobility management function (AMF) 120, a session management function (SMF) 125, a network repository function (NRF) 130, a policy control function (PCF) 135, a unified data management (UDM) 140, and other functions (not shown in the example architecture 100).

In general, the UE device 105 or 107 connects to data networks (e.g., the internet) via the RAN 112 or 114 and the core network. The UE device 105 or 107 may send a connection request to the AMF 120, which may provide an entry point for the requested connection. For example, the UE device 105 sends a connection request via the base station 111 of the RAN 112, which forwards the request to the AMF 120. Based on the service requested by the UE device, the AMF 120 selects an SMF 125 for managing the user session. In some cases, a user plane function (UPF, not shown) may transport the data traffic between the UE device and the data network. For controlling such data traffic, the PCF 135 may provide a policy control framework; the SMF 125 may apply policy decisions; and the UDM 140 may access subscription information to govern the behaviors of the RANs 112 and 114.

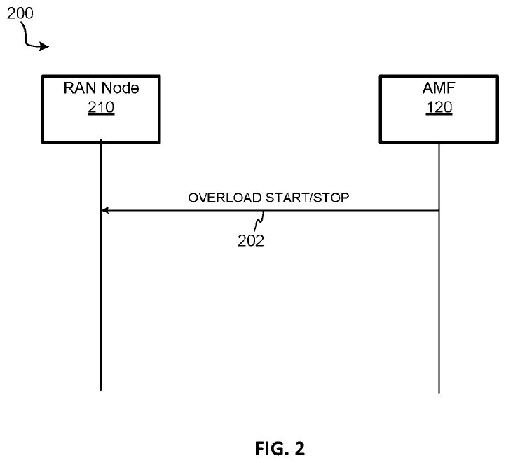

According to aspects of the present disclosure, when the AMF 120 detects an overloading situation, instead of automatically applying an overload protection procedure to the TAs in an RA and thus affecting all UEs in that registration area (example provided in FIG. 2), the AMF 120 may operate based on subscription information from the UDM 140 or RAN information from the NRF 130, to provide connection-specific responses. For example, some UE devices may have high priority as indicated in the subscription information (e.g., related to public service or government authority) in some service areas (e.g., tracking areas) of specific RANs.

The UDM 140 may store and provide subscription data including the subscription information and authentication data. The PCF 135 may use policy data (e.g., including priority category or priority threshold information) that may be stored in a unified data repository (UDR) 137. In some cases, a network operator records or assigns the subscription information and the associated priority level or value in the UDM 140. The network operator may provide the policy data to define a priority category for overload exemptions. For example, the priority level may include low, medium, or high categories and the operator may define “medium” or “high” as the priority threshold. In some examples, the priority level may include a specific numeric value and the operator may define a priority threshold value for comparison with the UE specific or TA specific priority level. During operation, the AMF maintains the priority threshold (e.g., once defined) as part of the network configuration. In some cases, the AMF conveys the priority threshold to the RANs 112 and 114 (and the BSs 111 and 113) through an overload start message (discussed in relation to FIG. 2 below).

FIG. 2 is an example diagram depicting an overload protection procedure 200, according to some embodiments. As shown, the AMF 120 may initiate an overload protection procedure by informing the RAN node 210 (e.g., including the BS 111 or 113 of FIG. 1) to reduce the signaling load toward the AMF 120. The overload protection procedure uses non-UE associated signaling. For example, the AMF 120 transmits a message 202 to the RAN node 210 for starting or stopping an overload protection procedure.

When the AMF 120 detects an overloaded state, the AMF 120 sends an overload start message 202 to the RAN node 210. The overload start message 202 may include an information element that identifies signaling traffic contributing to the overloaded state. The message 202 may also include one or more overload action information elements, instructing the RAN node 210 to reject connection establishments or permit certain connection establishments. Accordingly, the RAN node 210 may send to the AMF 120 only the signaling traffic not indicated as rejected by the message 202. That is, the overload start message 202 does not include any UE-specific or TA-specific information and provides generic categorization regarding the signal types to be rejected or allowed (e.g., emergency signals). When the overloaded state is resolved, the AMF 120 sends an overload stop message 202 to the RAN node 210 for resuming normal operation. Although FIG. 2 depicts the overload stop message as a toggle-mechanism message 202, in other implementations, the overload stop message has a different structure or different content from the overload start message.

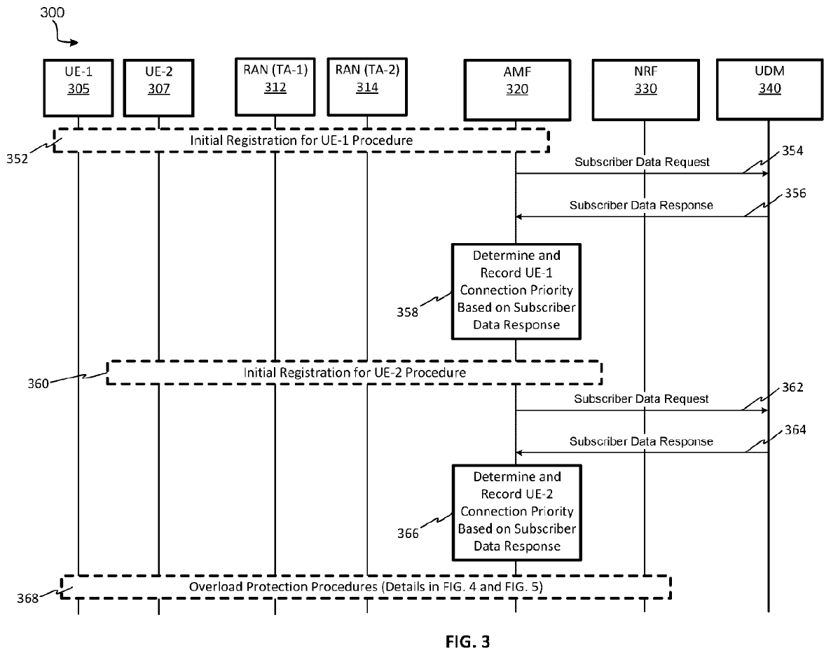

According to aspects of the present disclosure, the AMF 120 may include, in the overload start message 202, information elements (IEs) related to priority threshold information. For example, when high priority TAs are exempt from initiating the overload protection, the AMF 120 may include the following information in the overload start message 202:
. . .
TA-123-Level: High
TA-456-Level: Med
TA-High-Policy: AllowConnection
TA-Med-Policy: Allow_50_Percent
. . .
   Accordingly, the RAN node 210 may allow the TA-123 to continue establishing new connections with incoming UE registration requests, as further discussed in FIGS. 3-5 below.

FIG. 3 is a signaling diagram 300 depicting example registration requests by multiple UE devices (e.g., the UE devices 305 and 307) and a method of connection-specific overload protection, according to some embodiments. The UE devices 305, 307 correspond to UE devices 105, 107 of FIG. 1. Similarly, RANs 312, 314 correspond to RANs 112, 114 implemented using BSs 111, 113 of FIG. 1. And AMF 320, NRF 330, and UDM 340 correspond to their counterparts in FIG. 1. As shown, the first UE device 305 and the second UE device 307 may each attempt an initial registration with the AMF 320 via the first RAN 312 and/or the second RAN 314.

For example, when moving into a coverage area (e.g., TA) of one of the RANs 312 or 314, the first UE device 305 transmits 352, via a BS of at least one of the RANs, a request to the AMF 320 for registration or authentication. The request includes a subscription permanent identifier (SUPI) uniquely identifying the UE For example, the SUPI may include an international mobile subscriber identity (IMSI) or a network access identifier (NAI). The request may use other non-SUPI unique identifiers, such as international mobile equipment identify (IMEI), manufacturer serial number, or carrier phone number. Each of the RANs 312 and 314 may provide one or more different Tas covering different physical areas, which may overlap. The UE device 305 may travel into one of the one or more TAs and sends the request to the corresponding RAN.

Upon receiving the registration request, the AMF 320 transmits 354 a subscriber data request to the UDM 340. The subscriber data request includes an indicator or identifier of the first UE device 305 such as the IMSI of the first UE device 305 or a global unique temporary identifier (GUTI) allocated by the AMF 320. In response to the subscriber data request, the UDM 340 returns 356 a subscriber data response to the AMF 320. The subscriber data response may indicate a priority level regarding a connection between the UE device 305 and the RAN (e.g., via which the AMF 320 receives the registration request). For example, the priority level includes a value in the subscriber data indicating an assigned level of UE device priority (e.g., 0 or 1, or from 1 through n, the greater the value indicating a higher level of priority). The priority level may also include a restriction of the UE device priority to one or more particular TAs/RNAs, with the UE device priority being 0 outside those particular TAs/RNAs. The AMF may recognize an overload protection mechanism threshold priority level (e.g., of value m, m being 1 or greater) for any UE device associated with a RAN. In some cases, the AMF 320 receives the device priority level pre-registered at the UDM 340 as a priority value associated with the ID of the UE device.

The AMF 320, in view of the subscriber data response, determines and records 358 connection priority regarding the specific connection of the first UE device 305 (in the case of UE device-specific priority). In addition to UE device priority, the connection priority may reflect a priority level of a TA of the RAN, or a priority level of a TA-specific UE priority (e.g., the priority of the UE device recognized at specific TAs). This will be discussed in detail below.

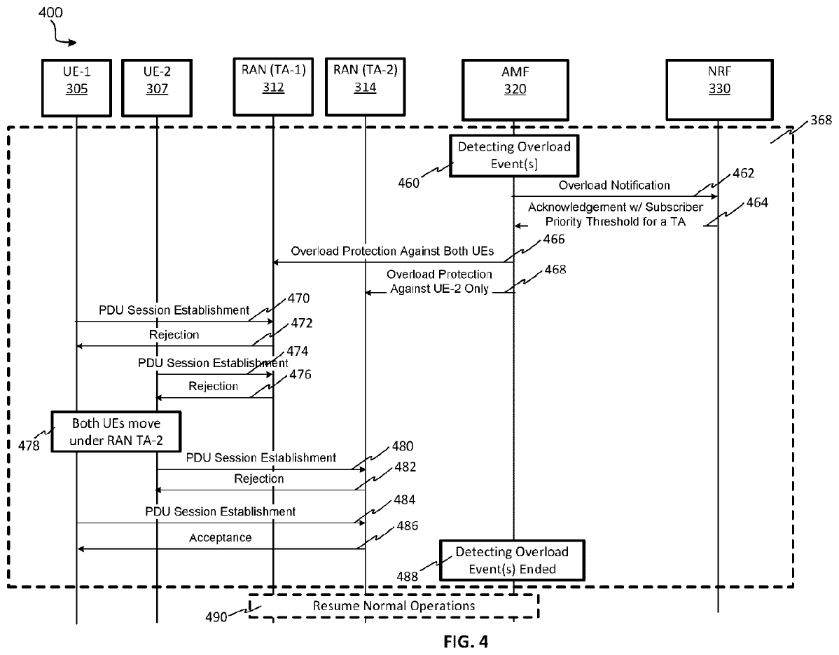

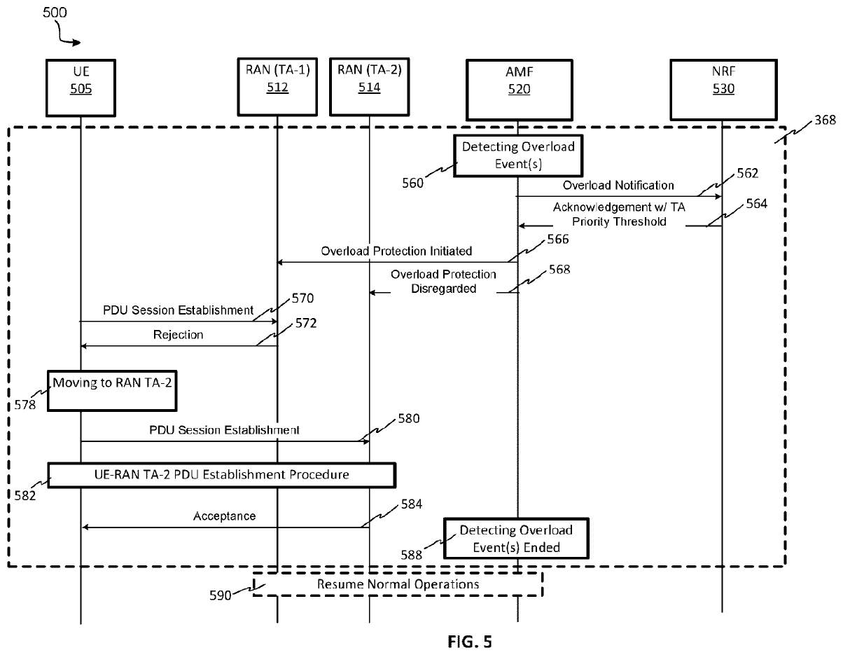

Similar to the registration request procedures of the first UE device 305, the second UE device 307 may also transmit 360 a request to the AMF 320 for registration or authentication via at least one of the RANs 312 and/or 314. The AMF 320 may similarly send 362 a subscriber data request to the UDM 340, which returns 364 a subscriber data response. The AMF 320 determines and records 366 connection priority regarding the specific connection of the second UE device 307. The AMF 320 may provide 368 the RANs 312 and 314 overload protection procedures according to the recorded connection priority information, as further discussed with respect to FIG. 4 and FIG. 5.

FIG. 4 is a signaling diagram 400 depicting an example execution of connection-specific overload protection 368 during traffic overload in response to the registration requests shown in FIG. 3, according to some embodiments. The connection-specific overload protection may apply to specific UE devices, such as an official's work phone (e.g., a smart phone having a subscription indicating that the user is a designated official at certain security levels), a police officer's work phone, or a firefighter's work phone, etc. The connection-specific overload protection may specify the connection scenarios to specific TAs (or RNAs). For example, the priority levels are specific to a UE device attempting to connect to BSs at certain TAs/RNAs, such that the police officer's work phone may have high priority in security related areas but not other areas, or such that the officer's work phone may have high priority only within relevant official buildings or campuses.

As shown in FIG. 4, the AMF 320 detects 460 one or more overload events or states during operation. Upon detecting the one or more overload events, the AMF 320 sends 462 an overload notification to the NRF 330, which stores tracking area (TA) specific priority information about the RANs 312 and 314. The overload notification indicates one or more UE devices and one or more BSs of the RANs 312 and 314 affected by the overload event 460. The AMF 320 then receives 464 an acknowledgement message from the NRF 330 with priority information about the RANs 312 and/or 314 (e.g., depending on which RAN was indicated in the registration request). For example, the TA of the first RAN 312 does not have a TA priority level that overrides the overload protection procedure.

As a result, the AMF 320 initiates 466 (e.g., by sending an indication of action) overload protection at the TA of RAN 312 against both of the UE devices 305 and 307 (when these UEs request registration) as described with respect to FIG. 2. In some embodiments, the overload protection at RAN 312 applies to new registration attempts by other UE devices (e.g., rejecting the registration request because the TA of RAN 312 has low priority).

On the other hand, the priority information from the acknowledgement 464 may indicate that the TA of the second RAN 314 has overload protection exemption for any UE device having a UE device priority level above a given first threshold. If the first UE 305 has a UE device priority level above the first threshold that is valid in that TA/RNA, then the UE 305 is not subjected to the overload protection mechanism while registered to RAN 314 (e.g., the connection between the first UE device 305 and the second RAN 314 is not subject to interruption or rejection by the overload protection). As such, the AMF 320 initiates 468 (as described with respect to FIG. 2) overload protection against the second UE device 307, which has a UE device priority level below the first threshold in this example. In some cases, other UE devices have priority level assignments above the threshold and thus receive overload protection exemption similar to the UE device 305. Meanwhile, additional UEs with UE device priority levels below the first threshold are subject to the overload protection mechanism while registered to RAN 314 (e.g., the AMF 320 sends 468 an overload start message similar to the message 202 of FIG. 2 to reject the registration requests of the additional UEs).

When either UE device 305, 307 moves within the signal coverage by the TA of the first RAN 312, the UE devices 305 and 307 may respectively transmit connection requests to the first RAN 312. For example, the first RAN 312 receives 470 a PDU session establishment request from the first UE 305. In response, having received 466 the overload protection configurations from the AMF 320, the first RAN 312 rejects 472 the request. Similarly, the first RAN 312 receives 474 a PDU session establishment request from the second UE 307, and rejects 476 in view of the configurations received 466 from the AMF 320.

When both the UE devices 305 and 307 move 478 within the signal coverage by the TA of the second RAN 314, the UE devices 305 and 307 may respectively transmit connection requests to the second RAN 314. For example, the second RAN 314 receives 480 a PDU session establishment request from the second UE 307. In response, having received 468 the overload protection configurations, the second RAN 314 rejects 482 the request, because the second UE 307 has a subscriber priority level below the first threshold. However, when the second RAN 314 receives 484 a PDU session establishment request from the first UE 305, because of the UE device priority level being above the first threshold and a TA priority exemption against the overload protection procedures configured at 468, the second RAN 314 accepts 486 the request and allows for a PDU session establishment (not shown). In some cases, one UE device (305 or 307) may move between two or more TAs of a RAN. The UE device may receive similar treatment regarding overload protection exception due to UE specific, TA specific, or UE-TA specific priorities as moving between two or more RANs, as shown in FIGS. 4 and 5.

When the AMF 320 detects 488 that the one or more overload event(s) having ended, the AMF 320 indicates 490 to the first and the second RANs 312 and 314 to resume normal operations (e.g., regarding future connection requests). For example, similar to the message 202 of FIG. 2, the AMF 320 may transmit 490 an overload stop message respectively to the RAN 312 and RAN 314. The overload stop message may reset configurations affected by the messages 466 and 468 that have configured the RANs 312 and 314 earlier during overload.

FIG. 5 is a signaling diagram 500 depicting another example execution of connection-specific overload protection 368 during traffic overload, according to some embodiments. Compared to FIG. 4, FIG. 5 illustrates a scenario of a specific UE device 505 receiving different connection request responses because of different TA priority configurations (e.g., the first TA of the first RAN 512 and the second TA of the first RAN 512 (or a different, second RAN 514) have different TA priority thresholds for overload protections). The UE device 505 corresponds to the UE device 105 of FIG. 1 and 305 of FIG. 3. Similarly, RANs 512 and 514 correspond to the RAN 112 and 114 implemented using BS 111 and BS 113 of FIG. 1, or RANS 312 and 314 of FIG. 3. For example, the AMF 520 may not initiate overload protection procedures to a base station of the second RAN 514 when the second TA of the second RAN 514 has a high TA priority status (e.g., above a second threshold such that it is exempt from overload start messages). Such high priority TA or BS of the second RAN 514 may include BSs in emergency rescue regions (e.g., earthquake regions, hospitals, wildfire regions, etc.) and/or high security regions (e.g., police station, buildings for public safety or national defense, etc.).

As shown in FIG. 5, the AMF 520 detects 560 one or more overload events similar to event 460. In response to the detection, the AMF 520 sends 562 an overload notification to the NRF 530 similar to event 462. The NRF 530 responds 564 with an acknowledgement message, similar to event 464 but without UE device priority information, and instead including the priority threshold for the TAs of the RANs associated with the AMF 520. According to the second threshold for TA priority in the acknowledgement message, the AMF 520 initiates 566 (e.g., by sending an indication of action, such as an overload start message per FIG. 2) overload protection at the first RAN 512 which has a TA priority level that does not exceed the second threshold. However, because the second RAN 514 has a priority level against overload protection that exceeds the second threshold, the AMF 520 disregards initiating overload protection at the second RAN 514. For example, the AMF 520 sends 568 a message (e.g., the message 202) to the second RAN 514 with a threshold indicator that allows UE devices (505 and others) to establish a session with TA-2. Alternatively, the AMF 520 does not send the message and allows 568 the second RAN 514 to perform PDU establishment procedures without overload protection.

When the UE device 505 moves within the coverage of the first TA of the first RAN 512, the UE device 505 sends 570 a PDU session establishment request to the first RAN 512. In response, the first RAN 512 rejects 572 the request because of the overload protection state as configured at 566.

When the UE device 505 moves 578 within the coverage of the second TA of the second RAN 514, the UE device 505 sends 580 a PDU session establishment request to the second RAN 514. Because the second RAN 514 is exempt from the overload protection as determined at 568, the second RAN 514 allows 582 the PDU establishment procedure to continue. In due course, the second RAN 514 accepts 584 the PDU session establishment request.

When the AMF 520 detects 588 that the one or more overload event(s) having ended, the AMF 520 indicates 590 to the first and the second RANs 512 and 514 to resume normal operations (e.g., regarding future connection requests, similar to event 490 of FIG. 4).

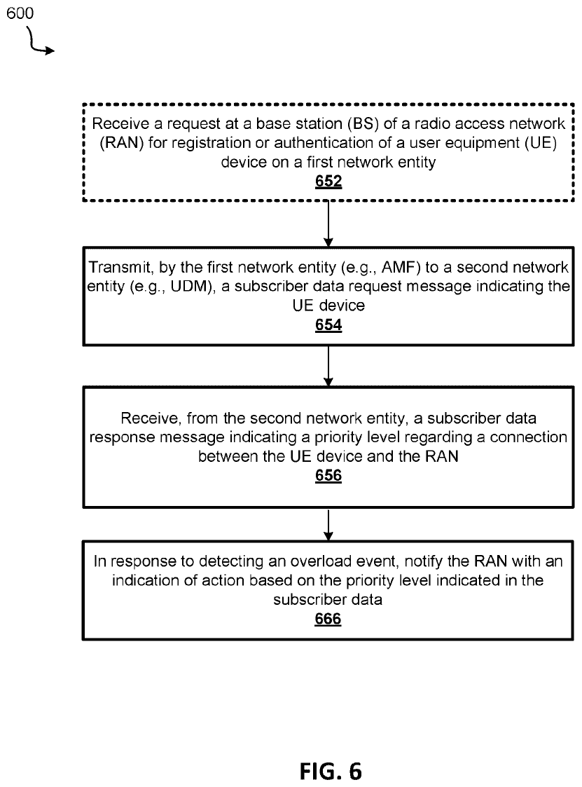

FIG. 6 is a flow diagram 600 depicting a method for implementing connection-specific overload protection by a first network entity (e.g., an AMF), according to some embodiments. The method of the flow diagram 600 is performed by a first network entity, such as the AMF 120, 320, or 520 of FIGS. 1-5.

As shown in FIG. 6, the method includes, in some embodiments, receiving 652 a request (e.g., a registration request from a UE device) at a base station (BS) of a RAN for registration or authentication of a UE device on the first network entity (e.g., operation 352 of FIG. 3). In some cases, the request may include a request for periodic registration after an initial registration.

The method includes transmitting 654, by the first network entity to a second network entity (e.g., a UDM 140, 340 of a New Radio (NR) network), a subscriber data request message including an indication of the UE device (e.g., operation 354 of FIG. 3) such as a UE device identifier. The request message may include a global unique temporary identifier (GUTI) of the UE device in the subscriber data request to the second network entity.

The method includes receiving 656, from the second network entity, a subscriber data response message including an indication of a priority level regarding a connection between the UE device and the RAN (e.g., operation 356 of FIG. 3). This priority level regarding the connection may include a subscriber priority level specific to the UE device, a TA priority level (also called an RNA priority level) specific to a TA/RNA through which the UE registered, or both types.

The method includes the first network entity notifying 666, in response to detecting an overload event (see, for example, 3GPP TS 23.501 Section 5.19), the RAN with an indication of action based on the priority level indicated in the subscriber data (e.g., operations 466 and 468 of FIG. 4, and 566 and 568 of FIG. 5). In some cases, notifying the RAN may include transmitting a first indicator to ignore the overload event when the TA priority level among different priority levels for one or more TAs of the RAN exceeds a second threshold level (e.g., a TA priority levels exceeds a second threshold level received in event 564).

For example, each BS (and the corresponding TA) has an assigned priority level designation. Certain overload events receive a priority threshold indication such as the second threshold received 564 in the NRF acknowledgement described with FIG. 5. The first network entity compares the TA priority level against the threshold level of the overload event to determine whether a BS of a RAN is subject to overload protection procedures. The first indicator may release or reject a connection between the UE device and the RAN, and indicate the overload event to the RAN when the TA priority level of the RAN is not above the threshold level.

In some cases, the first network entity receives device-specific priority level from a UDM or a UDR associated with the UDM. For example, the first network entity receives the device priority level pre-registered at the UDM as a priority value associated with the ID of the UE device. The first network entity may notify the RAN with an indicator that permits establishing or maintaining a connection between the UE and the RAN, and ignoring the overload event when the device priority level of the UE device is above a device priority threshold level. When the device priority level of the UE device is not above the device priority threshold level, the indicator may release or reject a connection between the UE device and the RAN, and indicate the overload event to the RAN.

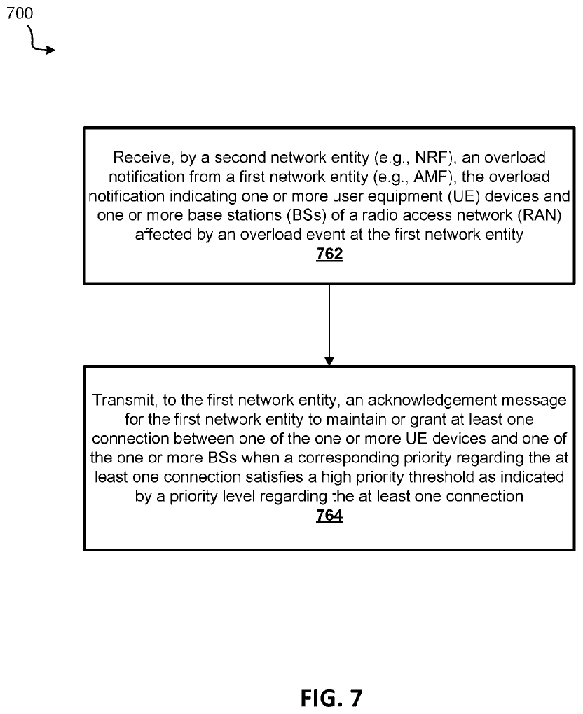

FIG. 7 is a flow diagram 700 depicting a method for wireless communications by a second network entity (e.g., an NRF, such as 330 or 530), according to some embodiments. The method of the flow diagram 700 is complementary to the method of the flow diagram 600 and is performed by a second network entity, such as the NRF 330 of FIG. 4 or the NRF 530 of FIG. 5.

As shown in FIG. 7, the method includes receiving 762 by a second network entity (e.g., the NRF 330 of FIG. 4 or the NRF 530 of FIG. 5), an overload notification (e.g., 462 or 562) from a first network entity (e.g., the AMF 320 of FIGS. 3-4 or the AMF 520 of FIG. 5), the overload notification indicating one or more user equipment (UE) devices and one or more base stations (BSs) of a radio access network (RAN) affected by an overload event at the first network entity.

The second network entity transmits 764, to the first network entity, an acknowledgement message for the first network entity to maintain or grant at least one connection between one of the one or more UE devices and one of the one or more BSs when a corresponding priority regarding the at least one connection satisfies a high priority threshold as indicated by a priority level regarding the at least one connection. For example, the corresponding priority regarding the at least one connection includes a UE device priority (e.g., specific to the UE device), a tracking area (TA) priority, or both.

When the corresponding priority includes a UE device priority, the first network entity obtains the UE device priority by querying a UDM, using a GUTI to identify the UE device, and receives (e.g., elements 464) the UE device priority from the UDM. The first network entity transmits (e.g., element 464) the UE device priority to the first network device and lets the first network device perform the comparison and determination (e.g., when the priority threshold is stored in the first network device). The second network entity compares the UE device priority and a priority threshold (e.g., predefined by an operator, such as low, medium, or high, or a numerical value) and determines whether the UE device priority satisfies the priority threshold. The first network device then includes the determination in the acknowledgement message (e.g., element 464) to the second network device.

When the corresponding priority includes a TA priority, the first network entity needs not query a UDM, because the second network entity has stored the TA priority information. The second network entity identifies the TA priority information based on the TA involved in the overload notification from the first network entity. Either the first network entity or the second network entity may perform the comparison between the TA priority level and a TA priority threshold level. For example, the second network entity transmits (e.g., element 564) the acknowledgement message including the TA priority information so that the first network entity determines whether the TA priority satisfies the corresponding priority threshold. In some cases, the second network entity makes the determination and may still transmit (e.g., element 564) the TA priority level along the acknowledgement message to the second network entity.

When both the TA priority and the UE device priority are considered (e.g., the overload mechanism exemption requires both priorities satisfy corresponding threshold levels), the second network entity receives, in the overload notification from the first network entity, a UE device priority of the UE device making the registration request (e.g., the first network entity queries a UDM and receives the priority information therefrom). The second network entity transmits (e.g., a combination of 464, 564) the acknowledgement message for the first network entity to maintain or grant at least one connection between the one UE of the one or more UE devices and the one BS of the one or more BSs when both the TA priority satisfies the corresponding TA priority threshold and the UE device priority satisfies the corresponding device priority threshold.

The method further includes transmitting 764, to the first network entity, an acknowledgement message for the first network entity to maintain or grant at least one connection between one of the one or more UE devices and one of the one or more BSs when a corresponding connection priority of the at least one connection satisfies a threshold as indicated by at least one priority level regarding the at least one connection (e.g., operation 464 of FIG. 4, or operation 564 of FIG. 5). The threshold can be specific to a UE device, a TA/RNA, or both. In this manner the first network entity is equipped to finely tune network overload protection mechanisms to reduce connection rejections or interruptions for any of, 1) high-priority UEs, 2) high-priority TAs/RNAs, or 3) high-priority UEs within specific TAs/RNAs.

With reference to FIGS. 6-7, a method illustrates example functions used by various embodiments. Although specific function blocks (“blocks”) are disclosed in method, such blocks are examples. That is, embodiments are well suited to performing various other blocks or variations of the blocks recited in method. It is appreciated that the blocks in method may be performed in an order different than presented, and that not all of the blocks in method may be performed. The method (of the flow diagram 600 or 700) is performed by processing logic that includes hardware (e.g., circuitry, dedicated logic, programmable logic, a processor, a processing device, a central processing unit (CPU), a system-on-chip (SoC), etc.), software (e.g., instructions and/or an application that is running/executing on a processing device), firmware (e.g., microcode), or a combination thereof.

Unless specifically stated otherwise, terms such as “establishing,” “receiving,” “transmitting,” or the like, refer to actions and processes performed or implemented by computing devices that manipulates data represented as physical (electronic) quantities within the computing device's registers and memories into other data similarly represented as physical quantities within the computing device memories or registers or other such information storage, transmission or display devices. Also, the terms “first,” “second,” “third,” “fourth.” etc., distinguish among different elements and may not necessarily have an ordinal meaning according to their numerical designation.

Examples described also relate to an apparatus for performing the operations described in this disclosure. This apparatus may be specially constructed for the required purposes, or it may include a general purpose computing device selectively programmed by a computer program stored in the computing device. Such a computer program may be stored in a computer-readable non-transitory storage medium.

The described methods and illustrative examples are not inherently related to any particular computer or other apparatus. Various general purpose systems may be used in accordance with the teachings described in this disclosure, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used in this disclosure, the singular forms “a,” “an” and “the” are intended to include the plural forms as well, unless the context clearly indicates otherwise. It will be further understood that the terms “comprises,” “comprising,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof. Therefore, the terminology used is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the present disclosure to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the present disclosure is not to be limited to the details given in this disclosure, but may be modified within the scope and equivalents of the appended claims.

### Example Aspects

Example 1. A method of wireless communications by an access and mobility management function, AMF (320), the method comprising:
transmitting (354), by the AMF to a unified data management, UDM, (340), a subscriber data request message indicating a user equipment, UE, device requesting registration at the AMF via a base station of a radio access network. RAN;
receiving (356), from the UDM, a subscriber data response message including a priority level regarding a connection between the UE device and the RAN; and
upon detecting (460) an overload event, notifying (466) the RAN, by the AMF, with an indication of action based on the priority level.

Example 2. The method of Example 1, wherein the transmitting the subscriber data request message comprises.
providing, from the AMF, a global unique temporary identifier, GUTI, of the UE device.

Example 3. The method of Example 1 or 2, wherein the receiving the subscriber data response message comprises:
obtaining a tracking area, TA, priority level of the base station, wherein the overload event is associated with at least a TA and wherein the notifying the RAN with the indication of action comprises:
   transmitting to the base station a first indicator to:
   (1) permit establishing or maintaining a connection between the UE device and the RAN notwithstanding the overload event when the TA priority level among different priority levels for one or more TAs of the RAN satisfies a TA priority threshold criterion, and
   (2) release or reject a connection between the UE device and the RAN, and indicate the overload event to the RAN when the TA priority level of the RAN does not satisfy the TA priority threshold criterion.

Example 4. The method of any of the Examples 1 to 3, wherein the receiving the subscriber data response message comprises:
obtaining a device priority level of the UE device from a unified data repository, UDR, associated with the UDM.

Example 5. The method of Example 4, wherein the notifying the RAN with the indication of action comprises:
transmitting a second indicator to:
(1) permit establishing or maintaining a connection between the UE device and the RAN notwithstanding the overload event when the device priority level of the UE device satisfies a device priority threshold criterion, and
(2) release or reject a connection between the UE device and the RAN, and indicate the overload event to the RAN when the device priority level of the UE device does not satisfy the device priority threshold criterion.

Example 6. The method of Example 4 or 5, wherein the device priority level is pre-registered at the UDM as a priority value associated with an identifier of the UE device.

Example 7. The method of Example 6 wherein the receiving the device priority level further comprises:
receiving a TA priority level, and the method further comprising:
establishing or maintaining a connection between the UE device and the RAN; and
ignoring the overload event when:
   (1) the device priority level of the UE device is above the device priority threshold level, and
   (2) the TA priority level of the RAN is above a TA priority threshold; and
otherwise releasing or rejecting the connection between the UE device and the RAN.

Example 8. The method of any of the Examples 1 to 7, further comprising:
receiving, from the UE device via the base station, a request for registration or authentication of the UE device.

Example 9. The method of Example 8, wherein the receiving the request for registration or authentication of the UE device comprises:
receiving a request for a periodic registration after an initial registration.

Example 10. A method of wireless communications by a network repository function, NRF (330), the method comprising:
receiving (462) an overload notification from an access and mobility management function, AMF (320), the overload notification indicating one or more user equipment, UE, devices and one or more base stations. BSs. of a radio access network, RAN, affected by an overload event; and
transmitting (464), to the AMF, an acknowledgement message for the AMF to maintain or grant at least one connection between one UE of the one or more UE devices and one of the one or more BSs when a UE device priority satisfies a first threshold criterion.

Example 11. The method of Example 10, further comprising:
transmitting, to the AMF, a priority level regarding the UE device priority.

Example 12. The method of Example 10, wherein the receiving the overload notification comprises:
receiving an identifier of at least one UE of the one or more UE devices;
determining the UE device priority at the NRF based on the identifier of the at least one UE device; and transmitting an indication of the UE device priority to the AMF.

Example 13. The method of any of Examples 10 to 12, wherein the transmitting the acknowledgement message comprises:
providing a tracking area, TA, priority level of a base station, to cause the AMF to notify the RAN to:
   (1) permit establishing or maintaining a connection between the UE device and the RAN notwithstanding the overload event when the TA priority level among different priority levels for one or more TAs of the RAN satisfies a TA priority threshold criterion, and
   (2) release or reject a connection between the UE device and the RAN, and indicate the overload event to the RAN when the TA priority level of the RAN does not satisfy the TA priority threshold criterion.

Example 14. A method of wireless communications by a network repository function, NRF (530), the method comprising:
receiving (562) an overload notification from an access and mobility management function, AMF (320), the overload notification indicating one or more user equipment, UE, devices and one or more base stations, BSs, of a radio access network, RAN, affected by an overload event; and
transmitting (564), to the AMF, an acknowledgement message for the AMF to maintain or grant at least one connection between one UE of the one or more UE devices and one BS of the one or more BSs when a tracking area, TA, priority satisfies a second threshold criterion.

Example 15. The method of Example 14, wherein the NRF stores the TA priority corresponding to the RAN affected by the overload event, and wherein the acknowledgement message comprises the TA priority.

Example 16. The method of Example 14, wherein the acknowledgement message is further for the AMF to maintain or grant at least one connection between one UE of the one or more UE devices and one of the one or more BSs when a UE device priority satisfies a first threshold criterion, wherein the acknowledgement message causes the AMF to:
(1) permit establishing or maintaining a connection between the UE device and the RAN notwithstanding the overload event when the UE device priority satisfies the first threshold criterion, and
(2) release or reject a connection between the UE device and the RAN, and indicate the overload event to the RAN when the UE device priority does not satisfy the first threshold criterion.

Example 17. A network entity comprising:
a processor; and
at least one memory storing executable instructions, the executable instructions to manipulate at least one of the processor to perform the method of any of Examples 1-16.

1-15. (canceled)

16. A method of wireless communications by an access and mobility management function (AMF), the method comprising:
transmitting, by the AMF to a unified data management (UDM), a subscriber data request message indicating a user equipment (UE) device requesting registration at the AMF via a base station of a radio access network (RAN);
receiving, from the UDM, a subscriber data response message including a priority level regarding a connection between the UE device and the RAN; and
upon detecting, by the AMF, an overload event involving multiple sessions from a number of UE devices, notifying the RAN, by the AMF, with an indication of action based on the priority level.

17. The method of claim 16, wherein the transmitting the subscriber data request message comprises:
providing, from the AMF to the UDM, a global unique temporary identifier (GUTI) of the UE device.

18. The method of claim 16, wherein the receiving the subscriber data response message comprises:
obtaining a tracking area, TA, priority level of the base station, wherein the overload event is associated with at least a TA and wherein the notifying the RAN with the indication of action comprises:
transmitting to the base station a first indicator to:
permit establishing or maintaining a connection between the UE device and the RAN notwithstanding the overload event when the TA priority level among different priority levels for one or more TAs of the RAN satisfies a TA priority threshold criterion, and
release or reject a connection between the UE device and the RAN, and indicate the overload event to the RAN when the TA priority level of the RAN does not satisfy the TA priority threshold criterion.

19. The method of claim 16, wherein the receiving the subscriber data response message comprises:
obtaining a device priority level of the UE device from a unified data repository (UDR) associated with the UDM.

20. The method of claim 19, wherein the notifying the RAN with the indication of action comprises:
transmitting a second indicator to:
permit establishing or maintaining a connection between the UE device and the RAN notwithstanding the overload event when the device priority level of the UE device satisfies a device priority threshold criterion, and
release or reject a connection between the UE device and the RAN, and indicate the overload event to the RAN when the device priority level of the UE device does not satisfy the device priority threshold criterion.

21. The method of claim 20, wherein the device priority level is pre-registered at the UDM as a priority value associated with an identifier of the UE device.

22. The method of claim 21 wherein the receiving the device priority level further comprises:
receiving a TA priority level, and the method further comprising:
establishing or maintaining a connection between the UE device and the RAN; and
ignoring the overload event when:
the device priority level of the UE device is above the device priority threshold level, and
the TA priority level of the RAN is above a TA priority threshold; and
otherwise releasing or rejecting the connection between the UE device and the RAN.

23. A method of wireless communications by a network repository function (NRF), the method comprising:
receiving an overload notification from an access and mobility management function (AMF), the overload notification indicating one or more user equipment (UE) devices and one or more base stations (BSs) of a radio access network (RAN) affected by an overload event involving multiple sessions from a number of UE devices; and
transmitting, to the AMF, an acknowledgement message for the AMF to maintain or grant at least one connection between one UE of the one or more UE devices and one of the one or more BSs when a UE device priority satisfies a first threshold criterion.

24. The method of claim 23, further comprising:
transmitting, to the AMF, a priority level regarding the UE device priority.

25. The method of claim 23, wherein the receiving the overload notification comprises:
receiving an identifier of at least one UE of the one or more UE devices;
determining the UE device priority at the NRF based on the identifier of the at least one UE device; and
transmitting an indication of the UE device priority to the AMF.

26. The method of claim 23, wherein the transmitting the acknowledgement message comprises:
providing a tracking area (TA) priority level of a base station of the one or more base stations.

27. A method of wireless communications by a network repository function (NRF), the method comprising:
receiving an overload notification from an access and mobility management function (AMF), the overload notification indicating one or more user equipment (UE) devices and one or more base stations (BSs) of a radio access network (RAN) affected by an overload event involving multiple sessions from a number of UE devices; and
transmitting, to the AMF, an acknowledgement message for the AMF to maintain or grant at least one connection between one UE of the one or more UE devices and one BS of the one or more BSs when a tracking area (TA) priority satisfies a second threshold criterion.

28. The method of claim 27, wherein the NRF stores the TA priority corresponding to the RAN affected by the overload event, and wherein the acknowledgement message comprises the TA priority.

29. The method of claim 27, wherein the acknowledgement message is further for the AMF to maintain or grant at least one connection between one UE of the one or more UE devices and one of the one or more BSs when a UE device priority satisfies a first threshold criterion, wherein the acknowledgement message causes the AMF to:
permit establishing or maintaining a connection between the UE device and the RAN notwithstanding the overload event when the UE device priority satisfies the first threshold criterion, and
release or reject a connection between the UE device and the RAN, and indicate the overload event to the RAN when the UE device priority does not satisfy the first threshold criterion.

30. An access and mobility management function (AMF) comprising:
a processor; and
at least one memory storing executable instructions, the executable instructions to manipulate at least one of the processor to:
transmit to a unified data management (UDM), a subscriber data request message indicating a user equipment (UE) device requesting registration at the AMF via a base station of a radio access network (RAN);
receive, from the UDM, a subscriber data response message including a priority level regarding a connection between the UE device and the RAN; and
upon detecting an overload event involving multiple sessions from a number of UE devices, notify the RAN with an indication of action based on the priority level.

31. The AMF of claim 30, wherein the processor is configured to transmit the subscriber data request message by providing, to the UDM, a global unique temporary identifier (GUTI) of the UE device.

32. The AMF of claim 30, wherein the processor is configured to receive the subscriber data response message comprises by:
obtaining a tracking area (TA) priority level of the base station, wherein the overload event is associated with at least a TA; and
wherein the processor is configured to notify the RAN with the indication of action by:
transmitting to the base station a first indicator to:
permit establishing or maintaining a connection between the UE device and the RAN notwithstanding the overload event when the TA priority level among different priority levels for one or more TAs of the RAN satisfies a TA priority threshold criterion, and
release or reject a connection between the UE device and the RAN, and indicate the overload event to the RAN when the TA priority level of the RAN does not satisfy the TA priority threshold criterion.

33. The AMF of claim 30, wherein the processor is configured to receive the subscriber data response message by:
obtaining a device priority level of the UE device from a unified data repository (UDR) associated with the UDM.

34. The AMF of claim 33, wherein the processor is configured to notify the RAN with the indication of action by:
transmitting a second indicator to:
permit establishing or maintaining a connection between the UE device and the RAN notwithstanding the overload event when the device priority level of the UE device satisfies a device priority threshold criterion, and
release or reject a connection between the UE device and the RAN, and indicate the overload event to the RAN when the device priority level of the UE device does not satisfy the device priority threshold criterion.

35. The AMF of claim 33, wherein the device priority level is pre-registered at the UDM as a priority value associated with an identifier of the UE device.
